(19) United States
(12) Patent Application Publication
(10) Pub. No.: US 2009/0051295 A1
(43) Pub. Date: Feb. 26, 2009

(54) APPARATUS FOR RADIATING AN OBJECT WITH UV RADIATION

(75) Inventors: Wilhelmus Ettes, Drachten (NL); Jacob Dijkstra, Drachten (NL); Andries Bron, Drachten (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.

(21) Appl. No.: 12/278,280

(22) PCT Filed: Jan. 25, 2007
(86) PCT No.: PCT/IB2007/050250

§ 371 Date: Aug. 5, 2008

(30) Foreign Application Priority Data
Feb. 7, 2006 (EP) 06101361.1

(51) Int. Cl. H05B 35/00

(52) U.S. Cl. 315/178

(57) ABSTRACT

An apparatus for radiating an object with UV-radiation, the apparatus comprises a series arrangement of an incandescent lamp (LA1) and a gas discharge UV lamp (L2) which generates at least UV light. The series arrangement is arranged for receiving current (IP) from an AC power source (PS). A controllable switching element (T1) is arranged for obtaining a lamp current (ILA1) through the incandescent lamp (LA1) to preheat the incandescent lamp (LA1) before igniting the gas discharge UV lamp (L2).

### FIELD OF THE INVENTION

The invention relates to an apparatus for radiating an object with UV radiation, and to a tanning apparatus.

### BACKGROUND OF THE INVENTION

WO 2005/034165 discloses a tanning apparatus for radiation treatment for personal care. The tanning apparatus comprises at least one gas discharge UV (Ultra Violet) lamp, at least one ballast connected in series with said at least one gas discharge lamp, and at least one incandescent lamp separate from the gas discharge lamp or lamps. The weight of the inductive ballast is reduced in that the incandescent lamp or lamps is or are included in the ballast or ballasts.

This tanning apparatus has the drawback that the start up current drawn from the mains during start up of the tanning apparatus is quite high if the incandescent lamp is cold because it does not have its operating temperature. It is commonly known to use a NTC (Negative Temperature Coefficient) resistor in series with the ballast to limit the start up current. However, such a NTC resistor has the drawback that it is a relatively expensive and bulky.

### SUMMARY OF THE INVENTION

It is an object of the invention to limit the start up current drawn from the mains without requiring a NTC resistor.

A first aspect of the invention provides an apparatus as claimed in claim 1. A second aspect of the invention provides a tanning apparatus as claimed in claim 18. Advantageous embodiments are defined in the dependent claims.

In the now following with the ignition voltage of the lamp is meant the voltage required to ignite a cold lamp. The re-ignition voltage is the voltage required to re-ignite the lamp during use such that the lamp becomes conductive again. With arc voltage is meant the voltage across the lamp after the lamp has been re-ignited. The re-ignition voltage strongly depends on the temperature of the ionized gas in the lamp. If a resistive ballast is used and current gaps occur, the re-ignition voltage will be higher than if an inductive ballast is used because the temperature of the gas drops. The re-ignition voltage operated with an inductive ballast on 50 or 60 Hertz is about 1.5 times higher than the arc voltage.

An apparatus in accordance with the first aspect of the invention comprises a series arrangement of an incandescent lamp and a gas discharge UV lamp. Preferably, the incandescent lamp is an IR (Infra Red) lamp which produces at least infrared light. Such an IR lamp has the advantage that it heats the person which is radiated by the UV light of the gas discharge UV lamp (further also referred to as UV lamp). The series arrangement of the incandescent lamp and the UV lamp is coupled to an AC power source (PS). The current supplied by the AC (Alternating Current) power source is also referred to as the power source current. The apparatus further comprises a controllable switching element, which is arranged for obtaining a lamp current through the incandescent lamp to preheat the incandescent lamp before igniting the UV lamp. Thus, the controllable switching element is arranged such that, during start up phase, the AC power source supplies a current through the incandescent lamp and not through the UV lamp. The current through the incandescent lamp heats the filament of the incandescent lamp. When the filament is heated sufficiently, its resistance is relatively high with respect to its resistance when cold, and the UV lamp can be ignited without causing a very high inrush current. Because now, the relatively high resistance of the heated incandescent lamp limits the start up current in the UV lamp, the prior art NTC resistor is not required. It has to be noted that the already present incandescent lamp, which is part of, or which forms the ballast for the UV lamp, is thus also used to limit the start up current in the UV lamp.

In an embodiment as claimed in claim 2, after the incandescent lamp has been pre-heated, an igniter generates an ignition voltage across the UV lamp to ignite the UV lamp. Such an igniter as such is well known. The igniter may be arranged in series or in parallel with the UV lamp. The igniter may generate the ignition voltage across the terminals of the UV lamp through which the current flows, or may use a separate electrode of the UV lamp.

In an embodiment as claimed in claim 3, the apparatus comprises a controller which controls the controllable switching element to obtain the lamp current through the UV lamp. The controller provides a level to a control input of the controllable switching element such that the controllable switching element forms a current loop from the AC current source through the incandescent lamp during the pre-heating phase wherein the incandescent lamp is pre-heated. The controller switches off the controllable switching element once the incandescent lamp is sufficiently pre-heated. Now the controller activates the igniter to ignite UV lamp. The incandescent lamp is sufficiently pre-heated once its impedance is sufficiently high to ignite the UV lamp with a limited start up current from the AC voltage source through the series arrangement of the incandescent lamp and the UV lamp.

In an embodiment as claimed in claim 4, the controller controls the switching element to obtain a lamp current through the incandescent lamp which increases in time. This prevents the low impedance of the incandescent lamp when cold to cause a relatively high current to be drawn from the AC power source. Many possibilities exist to control the switching element such that the current increases in time. For example, the switching element may be closed with a fixed repetition frequency while its on-time is increasing in time.

In an embodiment as claimed in claim 5, the apparatus has a first input terminal and a second input terminal for receiving the current from the power source. The series arrangement is coupled between the first input terminal and the second input terminal. The switching element when conductive couples the incandescent lamp between the first input terminal and the second input terminal and forms thereby a short circuit for a voltage supplied across the UV lamp. Thus, as long as the switching element is conductive the lamp current is flowing through the incandescent lamp, and no current flows through the UV lamp because the voltage across the UV lamp is zero. At the instant the filament of the incandescent lamp is sufficiently heated, the switching element is controlled to become non-conductive. Now, the controller activates the igniter and the UV lamp is ignited. Once the UV lamp is ignited, the current from the AC power source flows through the series arrangement of the incandescent lamp and the UV lamp.

In an embodiment as claimed in claim 6, the apparatus further comprises a failure detector which detects a failure in the apparatus. The controller activates the switching element to form a short-circuit for the voltage across the gas discharge UV lamp. Now, the AC power source only supplies the lamp current to the incandescent lamp. Failure detectors in apparatus which generate UV radiation are as such well known. For example, the failure detector detects a sticking of contacts of an on-off switch of the apparatus which is arranged in series with the series arrangement of the incandescent lamp and the UV lamp.

In an embodiment as claimed in claim 8, the failure detector tests whether the controller is operating correctly. If not, a relay is activated to disconnect the apparatus from the AC power source. For example, the failure detector tests whether the controller is generating a predefined pulse and if not, the relay is activated to disconnect the apparatus from the AC power supply.

In an embodiment as claimed in claim 10, the apparatus further comprises a generator which generates a generator current through the UV lamp. The generator current is at least supplied during periods in time the AC voltage generated by the AC power source has a level lower than an ignition voltage of the UV lamp. An amplitude and/or frequency of the generator current is selected to keep the gas discharge UV lamp at least ionized. Keeping the UV lamp ionized around zero crossings of the AC voltage has the advantages that the re-ignition of the UV lamp occurs at lower levels of the AC voltage. Consequently, the time periods around the zero crossings of the AC voltage during which no current flows through the UV lamp (these time periods are also referred to as the zero current gaps or just current gaps) become shorter, and the harmonic distortion of the current drawn out of the AC power source decreases. This might be a very important issue because usually the AC power source is the mains, and the amount of harmonic distortion allowed on the mains is strictly regulated.

It has to be noted that without the generator, no current at all is flowing through the UV lamp once the voltage across it drops below a predetermined level. This behavior is due to the resistive ballast formed by the incandescent lamp and is quite different from what happens with the usual inductive ballast. With an inductive ballast the phase difference between the current through the UV lamp and the voltage across the UV lamp still causes a current when the voltage is lower than the arc voltage (also referred to as ignition voltage) of the UV lamp. This phase difference also causes that the voltage across the UV lamp is higher than the arc voltage when the current is zero. Thus, in the present invention wherein an incandescent lamp is used as the ballast (or forms a major part of the ballast) current gaps occur which are not known from the prior art systems which use an inductive ballast. It has been found that during the period in time the generator current is supplied to the UV lamp, the impedance of the UV lamp allows a (relatively small) current from the AC power source to flow through the UV lamp. This even further decreases the amount of harmonics in the current drawn from the AC power source.

In an embodiment as claimed in claim 11, the generator generates the generator current with a repetition frequency higher than a frequency of the AC power source current. Preferably, the repetition frequency of the generator current is within the range from 50 kHz to 150 kHz, while the AC power source is the mains which usually supplies a sinusoidal voltage with a frequency of either 50 Hz or 60 Hz.

In an embodiment as claimed in claim 13, the apparatus further comprises a first impedance arranged between the AC power source and the incandescent lamp, and a second impedance arranged between the generator and UV lamp. The first impedance attenuates an amount of (preferably: blocks) the generator current flowing through the incandescent lamp to the AC power source. The second impedance attenuates an amount of (preferably: blocks) the AC power source current flowing through the generator. Preferably, the first impedance comprises or is a first inductor, and the second impedance comprises or is a first capacitor.

In an embodiment as claimed in claim 15, a second capacitor is arranged in parallel with the UV lamp and a second inductor is arranged in series with the first capacitor. A first resonance frequency of the first capacitor and the second inductor is selected to be lower than a minimal value of the repetition frequency of the generator current. A second resonance frequency of the second capacitor and the second inductor is selected to be higher than the first resonance frequency. The controller controls the generator to vary the repetition frequency of the generator starting from a value higher than the second resonance frequency to the minimal value. By varying the repetition frequency from above the second resonance frequency to below the second resonance frequency, at the second resonance frequency the voltage across the UV lamp becomes higher than the ignition voltage and the UV lamp is ignited. Once the UV lamp has been ignited the voltage across the UV lamp should be decreased. This is obtained by decreasing the repetition frequency below the second resonance frequency. The repetition frequency should not drop below the first resonance frequency to prevent the series arrangement to leave its inductive mode.

In an embodiment as claimed in claim 16, the controllable switching element comprises or is a triac which has the advantage that it can conduct current in two directions.

In an embodiment as claimed in claim 17, the incandescent lamp comprises or is an IR lamp for emitting at least infrared light.

The apparatus for radiating an object with UV-radiation may be used as a tanning apparatus for radiating a person with UV-radiation.

These and other aspects of the invention are apparent from and will be elucidated with reference to the embodiments described hereinafter.

### BRIEF DESCRIPTION OF THE DRAWINGS

In the drawings:

FIG. 1 shows a schematic block diagram of an embodiment of a tanning apparatus in accordance with the invention in which preheating of the incandescent lamp is implemented,

FIG. 2 shows schematically signals occurring in the apparatus shown in FIG. 1,

FIG. 3 shows schematically an alternative embodiment of the tanning apparatus,

FIG. 4 shows schematically another embodiment of the tanning apparatus,

FIG. 5 shows schematically an embodiment of the tanning apparatus which further comprises a generator for generating a high frequency current through the UV lamp,

FIG. 6 shows schematically another embodiment of the tanning apparatus with a high frequency generator,

FIGS. 7A and 7B respectively show the current through the UV lamp without and with the high frequency generator,

FIG. 8 shows schematically another embodiment of the tanning apparatus with a high frequency generator with a controllable frequency,

FIG. 9 shows a more detailed embodiment of the tanning apparatus,

FIG. 10 shows several currents elucidating the effect of the high frequency generator, and

FIG. 11 also shows currents elucidating the effect of the high frequency generator.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

Although the embodiments discussed in the detailed description of the Figures are directed to a tanning apparatus, the invention also covers other apparatus which have a UV lamp to radiate an object with UV radiation. The object may be a person, an animal, or a non-living object or material.

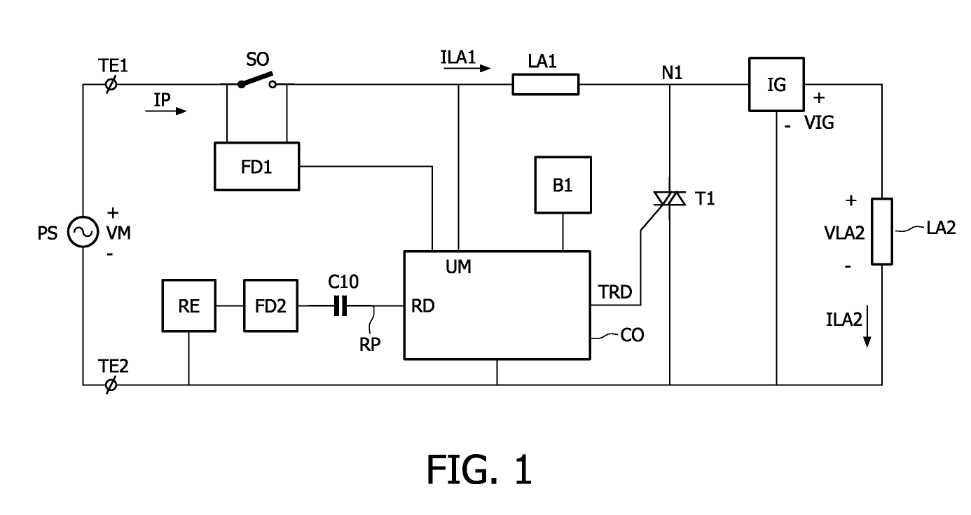

FIG. 1 shows a schematic block diagram of an embodiment of a tanning apparatus in accordance with the invention in which preheating of the incandescent lamp is implemented. The tanning apparatus has two input terminals TE1 and TE2 to receive an AC power supply voltage VM from an AC power source PS. The power source PS usually is the mains which has a frequency of 50 or 60 Hz. In the embodiment shown, a series arrangement of an on-off switch SO, a incandescent lamp LA1, an optional igniter IG and an UV lamp LA2 is connected between the terminals TE1 and TE2. It has to be noted that further elements may be present in this series arrangement. The igniter IG is optional and may thus be omitted, or may be positioned in parallel with the UV lamp LA2. In a tanning apparatus, the incandescent lamp is preferably an IR lamp which radiates at least infrared light to comfortably heating the person being radiated by the UV lamp LA2. The UV lamp LA2 may, for example, be an HPA (High Pressure UVA) lamp.

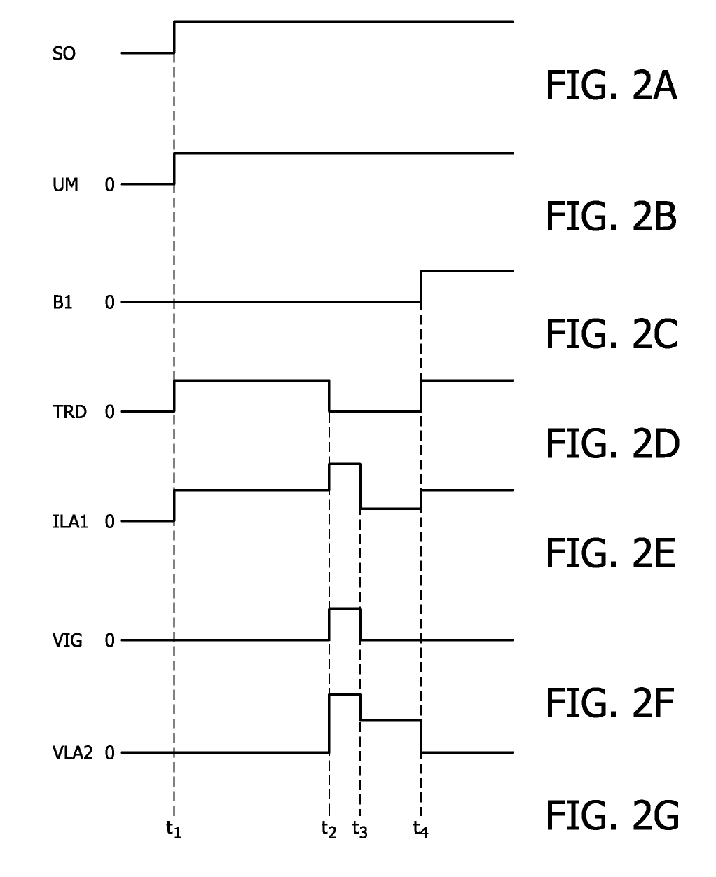

The relevant issue for the present invention is that a controllable switching element T1, which in the embodiment shown is a triac, is arranged to obtain a current ILA1 through the IR lamp LA1 while preventing current to flow through the UV lamp LA2. The UV lamp LA2 is ignited after the IR lamp LA1 is sufficiently preheated such that its impedance, which is predominantly resistive, is sufficiently high to limit a start up current through the UV lamp LA2. The pre-heating of the IR lamp LA1 before starting the UV lamp LA2 enables to omit the prior art NTC resistor in the series arrangement. The operation of the tanning apparatus shown in FIG. 1 is elucidated with respect to the signals shown in FIG. 2.

In the embodiment shown in FIG. 1, the triac T1 is arranged between a node N1 and the terminal TE2. The node N1 is the node in the series arrangement between the IR lamp LA1 and the UV lamp LA2. In the embodiment shown, the optional igniter IG is in-between the node N1 and the UV lamp LA2. The igniter IG supplies a relatively high ignition voltage VIG to the UV lamp LA2 when this lamp has to be ignited. Otherwise, the igniter IG transfers the voltage at the node N1. A controller CO controls the on and off switching of the triac T1 with the signal TRD. The controller CO has an input UM to receive the voltage at the node between the on-off switch SO and the IR lamp LA1, and a further input for receiving a user signal from a switch or button B1 indicating whether the UV lamp LA2 should be active or not. If the controller CO detects at one of these inputs that the UV lamp LA2 should be activated, first the IR lamp LA1 is preheated and then the UV lamp LA2 is switched on by igniting it.

The controller CO further may have inputs for receiving failure information. The failure detector FD1 detects whether a contact of the on-off switch SO sticks and indicates this misbehavior to the associated input of the controller CO. The controller CO than activates the triac T1 which short-circuits the voltage at the node N1 and thus causes the voltage across the UV lamp LA2 to drop to zero such that the UV lamp LA2 is switched off and it is prohibited that the person will be radiated too long with UV radiation.

Another failure occurs when the controller CO stops functioning correctly. To detect this failure, the controller CO has an output RD to supply a pulse signal RP to a capacitor C10. The failure detector FD2 checks whether the pulse signal RP is still present, and if not, it is clear that the controller CO stopped functioning correctly and a relay RE is activated to disconnect the apparatus, or at least the UV lamp LA2, from the mains PS.

FIG. 2 shows schematically signals occurring in the apparatus shown in FIG. 1. FIG. 2A shows the status of the on-off switch SO. A low level indicates that the switch SO is open, a high level indicates that the switch SO is closed. FIG. 2B shows schematically the voltage at the input UM of the controller CO. A low level indicates that there is no voltage and thus the switch SO is open, a high level indicates that there is a voltage and thus the switch SO is closed. The sinusoidal shape of the voltage at the input UM is not shown. FIG. 2C shows the status of the user button B1, a high level indicates that the user wants to have the UV-lamp switched off, a low level indicates that the user wants to have the UV-lamp switched on. FIG. 2D shows the switch signal TRD which is supplied to the control input of the triac T1. A low level indicates that the triac T1 is non-conductive, a high level indicates that the triac T1 is conductive. FIG. 2E shows the current ILA1 through the IR lamp LA1. FIG. 2F shows the ignition voltage VIG supplied by the igniter IG, and FIG. 2G shows the voltage VLA2 across the UV lamp LA2.

At the instant t1, when the tanning apparatus is switched on by closing the on-off switch SO, the controller CO detects the mains voltage VM at its input UM and controls the triac T1 to become conductive. Consequently the current ILA1 starts flowing through the IR lamp LA1. On the other hand the triac T1 short-circuits the voltage at the node N1. Consequently, the voltage VLA2 across the UV lamp LA2 is low because the igniter IG is inactive, and thus no current ILA2 flows through the UV lamp LA2. In FIG. 2D it is shown that the triac T1 is switched on continuously between the instants t1 and t2. Alternatively, the triac on-time may be slowly increasing during this or part of this period in time. Although the current ILA1 is shown to be constant in the period from the instant t1 to the instant t2, the actual shape depends on whether the triac T1 is switched on continuously or with a varying duty cycle, and in the latter situation, how the duty cycle varies.

At the instant t2, the IR lamp LA1 is sufficiently heated and its resistance is sufficiently high to limit the inrush current of the yet cold UV lamp LA2. Now the UV lamp LA2 can be ignited. The ignition pulse or pulses last from the instant t2 to t3 as shown in FIG. 2F. FIG. 2E shows that the instant t2 the current ILA1 through the IR lamp increases due to the current generated by the igniter IG. However it has to be noted that the current through the triac T1 does not flow anymore, and depending on the construction of the igniter IG, the current ILA1 may alternatively be constant or may decrease.

At the instant t3, the UV lamp LA2 is ignited, the ignition pulse(s) VGI stop and the current ILA1 is now the current which flows through the series arrangement of the IR lamp LA1 and the UV lamp LA2. Or said differently, the currents ILA1 and ILA2 are identical.

At the instant t4, the user presses the optional button B1 to indicate that the UV lamp LA2 should be switched off. The controller CO controls the triac T1 to become conductive, the voltage supplied to the UV lamp LA2 is short-circuited and the UV lamp LA2 switches off. The IR lamp LA1 is now connected between the terminals TE1 and TE2 and thus receives the power supply voltage VM. However the continuous on state of the IR lamp LA1 cannot harm the person.

If the failure detector FD1 detects that a contact of the switch SO is sticking this is forwarded to the controller CO which again controls the triac T1 to become conductive thereby switching off the UV lamp LA2 as discussed hereinabove.

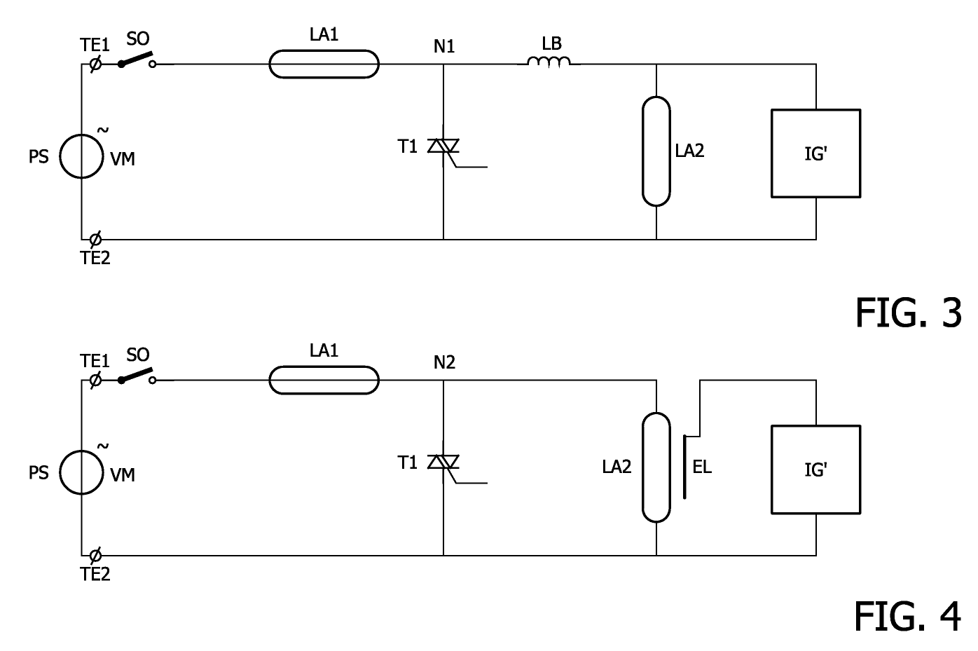

FIG. 3 shows schematically an alternative embodiment of the tanning apparatus. FIG. 3 shows a series arrangement of the on-off switch SO, the IR lamp LA1, a blocking inductor LB, and the UV lamp LA2. The series arrangement is arranged between the terminals TE1 and TE2 to receive the power supply voltage VM from the mains PS. The triac T1 is arranged in parallel with the series arrangement of the blocking inductor LB and the UV lamp LA2. Instead of the series igniter IG of FIG. 1, now a parallel igniter IG′ is used. The control of the triac T1 and operation of the circuit shown in FIG. 3 is almost identical to the circuit shown in FIG. 1. After the IR lamp LA1 has been heated by switching on the triac T1, the triac T1 is switched off, the igniter IG′ ignites the UV lamp LA2 and the normal operating current for the UV lamp LA2 is supplied from the mains via the IR lamp LA1 and the blocking inductor LB. The blocking inductor LB blocks the ignition pulses towards the node N1.

FIG. 4 shows schematically another embodiment of the tanning apparatus. The circuit of FIG. 4 only differs from the circuit of FIG. 3 in that the igniter IG′ now supplies the ignition voltage to a separate electrode EL of or near to the UV lamp.

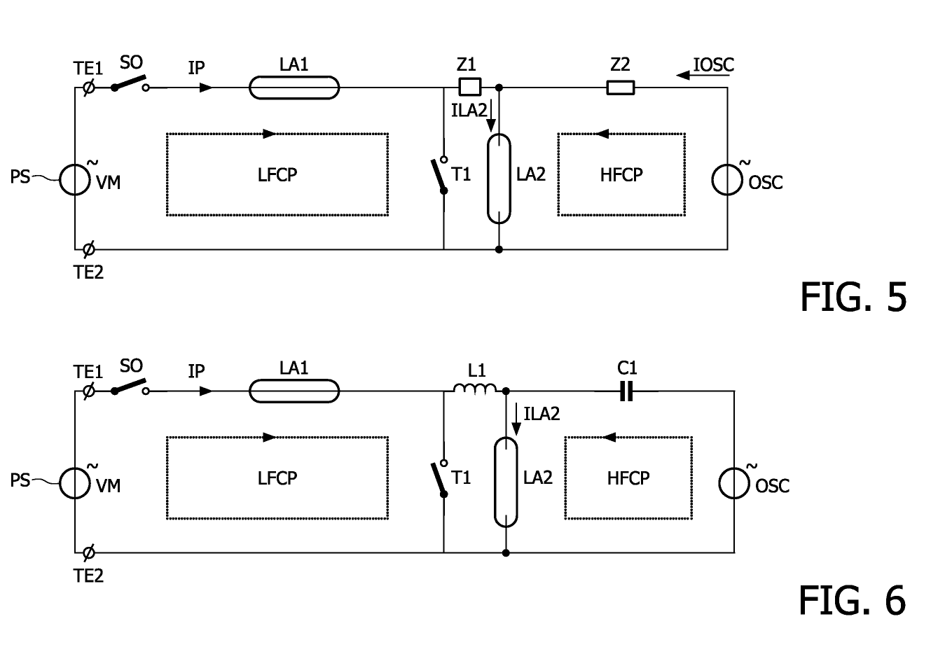

FIG. 5 shows schematically an embodiment of the tanning apparatus which further comprises a generator for generating a high frequency current through the UV lamp. FIG. 5 shows a series arrangement of the on-off switch SO, the IR lamp LA1, an impedance Z1, and the UV lamp LA2. The series arrangement is arranged between the terminals TE1 and TE2 to receive the power supply voltage VM from the power supply PS, which usually is the mains. The switching element T1 is arranged in parallel with the UV lamp LA2. Alternatively, the switching element T1 may be arranged in parallel with the series arrangement of the impedance Z1 and the UV lamp LA2. A series arrangement of a generator OSC and an impedance Z2 is arranged in parallel with the UV lamp LA2. The generator OSC, when active, supplies a current IOSC.

The controller (not shown) controls the switch T1 in a same manner as described with respect to FIGS. 1 to 3, or 4. The controller supervises whether the UV lamp LA2 should be switched on. For example, the controller detects the closing of the on-off switch SO or of any other user button indicating that the UV lamp LA2 should be switched on. Then, the controller closes the switch T1 to first heat the IR lamp LA1. Once the IR lamp LA1 is heated and its resistance is relatively high, the switch T1 is opened and the UV lamp LA2 is ignited.

It has to be noted that during normal operation the series arrangement of the IR lamp LA1, the impedance Z1, and the UV lamp LA2 receives the mains voltage VM. The impedance Z1 has a relatively low value for the mains frequency current IP which now is identical to the current ILA2 through the UV lamp LA2. Because the filament IR lamp LA1 behaves as a resistive ballast, the mains current IP drawn by the UV lamp LA2 has a non-sinusoidal wave shape. The current ILA2 through the UV lamp LA2 and thus the current IP from the mains is zero around the zero crossings of the mains voltage VM because the mains voltage VM has a level which is too low to keep the UV lamp LA2 ionized. For example, a UV lamp may have an arc voltage ranging from 100V to 140V dependent on the type of lamp used. Consequently, every half mains period of the mains voltage VM, the voltage across the UV lamp LA2 becomes too low to keep the current ILA2 flowing through the UV lamp LA2 and the UV lamp LA2 extinguishes. These gaps in the lamp current ILA2 and thus in the mains current IP, cause a high amount of mains pollution on the mains.

Theoretically, the UV lamp LA2 reignites as soon as the momentary voltage across it rises above its arc voltage. However, during the period in time that no current ILA2 flows through the UV lamp LA2, the momentary dissipation in the UV lamp LA2 is zero and the temperature of the plasma inside the UV lamp LA2 rapidly decreases and the UV lamp LA2 de-ionizes. The de-ionization of the UV lamp LA2 results in a decreased conductivity of the lamp. The re-ignition of a (partly) de-ionized UV lamp LA2 is much more difficult and requires a higher voltage. It has been found that a particular (UV) HPA lamp required a mains voltage of higher than 200V instead of 140V to re-ignite. The result is a non-sinusoidal mains current IP with a high harmonic content. The maximum levels of harmonic currents that are allowed to be drawn from the mains socket by household appliances are prescribed in IEC 61000-3-2 (Class C).

It has to be noted that UV lamps driven by an inductive ballast do not have problems with discontinuous, non-sinusoidal, mains currents and high harmonic content. In such systems, the lamp current ILA2 is about 45° lagging with respect to the mains voltage VM. The lamp current ILA2 and the lamp voltage are of course in phase. At the instant the lamp current ILA2 passes zero, the momentary mains voltage is about 250V (325V*sin(45°)). This re-ignition voltage is much higher than the lamp arc voltage. The UV lamp LA2 almost immediately re-ignites after the zero crossing of the UV lamp LA2 current. Consequently, the period during which the lamp current ILA2 is zero is very short, for example, about 0.1 ms.

The high harmonic content in the mains current IP when using a resistive ballast is decreased by using an auxiliary high frequency (HF) power source OSC. The HF power source OSC generates a HF current IOSC through the UV lamp LA2 to keep the UV lamp LA2 ionized nearby the zero crossings of the mains voltage VM when the voltage across the UV lamp LA2 is lower than its arc voltage. Now, the UV lamp LA2 is still ionized when the absolute value of the momentary mains voltage VM starts increasing, and the UV lamp LA2 is ignited earlier thereby shortening the zero current gap. Consequently, the harmonic content in the mains current IP decreases.

The current ILA2 through the UV lamp LA2 comprises a low frequency (LF) part IP supplied by the mains power source PS and a HF part IOSC supplied by the HF power source OSC. The mains current IP is larger than the HF current IOSC. The mains current IP is stabilized by the resistive ballast which is the IR lamp LA1. Preferably, the impedances Z1 and Z2 are added to create two separate LF and HF current paths. The inductive impedance Z1 prevents the HF current IOSC to flow through the IR lamp LA1 and the mains. The capacitive impedance Z2 prevents the LF current IP to flow into the HF source OSC. Preferably, the impedance Z1 is an inductor and the impedance Z2 is a capacitor, but more complex circuits having the desired effect can be used.

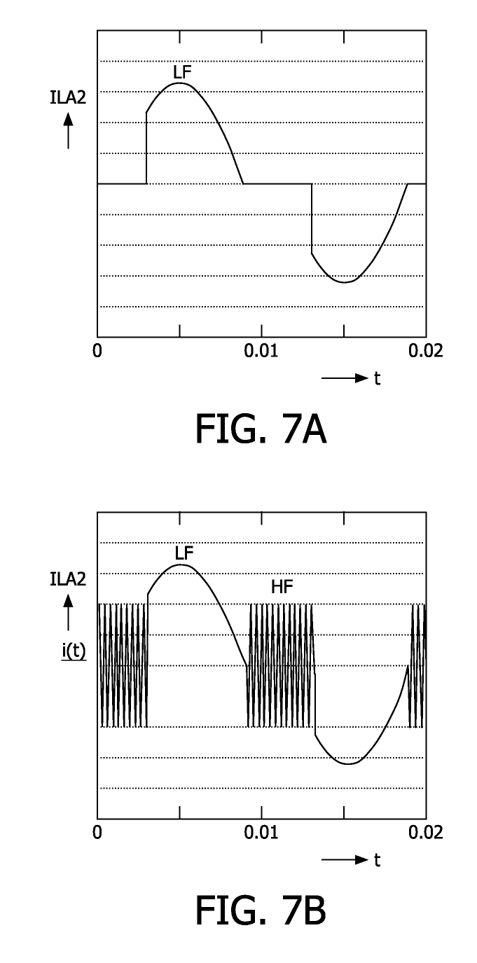

The HF source OSC may operate intermittently. If the momentary mains voltage VM becomes lower than the arc voltage of the UV lamp LA2, the mains PS no longer supplies power to the UV lamp LA2 and the HF source OSC is switched on. The HF source OSC supplies HF power to the UV lamp LA2 until the momentary mains voltage VM has a level sufficiently high to again supply LF power from the mains PS to the UV lamp LA2. Now, the HF source OSC is switched off. For example, the total operation time of the HF source OSC is about 4 ms, it is switched on approximately 2 ms before the zero crossing of the mains voltage VM and it is switched off approximately 2 ms after the zero crossing of the mains voltage VM, see FIG. 7B. Alternatively, the HF source OSC may be on continuously, and/or the amplitude of its current IOSC my be controlled to be higher during the zero current gap than otherwise.

Tests with a prototype of the hybrid ballast, which comprises the resistive ballast (the IR lamp LA1) and the HF power source OSC, show that the resistive part of the ballast supplies extra current nearby the zero crossings of the mains voltage VM if the HF power source OSC is active. From a theoretical point of view this is a quite unexpected behavior. Theoretically, the resistively operated UV lamp LA2 requires a mains voltage VM which has a level higher than the arc voltage of the UV lamp LA2 before current ILA2 can flow through the UV lamp LA2. The unexpected supply of current IP from the mains PS is caused by the fact that the HF power source OSC has an open voltage which is higher than the arc voltage of the UV lamp LA2. Thus, the HF power source OSC keeps the UV lamp LA2 ionized. The increased ionization level of the UV lamp LA2 around the zero crossing of the mains voltage VM results in an increased conductivity (lower resistance) of the UV lamp LA2. This decreased resistance allows the mains power source PS to supply LF current IP to the UV lamp LA2 during a period in time that otherwise no mains current IP can be supplied because the momentary mains voltage VM is lower than the arc voltage. This LF current IP during the zero current gaps further decreases the harmonic distortion of the mains current IP.

It further appeared that the ratio between the power in the IR lamp LA1 and the power in the UV lamp LA2 can be decreased by adding the HF power source OSC. For example in a practical implementation, with an inactive HF power source OSC, if the arc voltage of the UV lamp LA2 is about 110 V, a total power of 700 W is consumed, 400 W in the IR lamp LA1 and 300 W in the UV lamp LA2. Thus, the ratio of UV power and IR power is 1:1.33. It is now assumed that in the same system the HF power source OSC is activated, at least during the zero current gaps. The HF power source OSC supplies 30 W to the UV lamp LA2, and via the IR lamp LA1 370 W is supplied to the UV lamp LA2. The power in the UV lamp LA2 thus becomes 400 W and the power in the IR lamp LA1 becomes 430 W. Consequently, the ratio of UV power and IR power changes into the more favorable 1:1.08.

The power ratio can even be more improved if an UV lamp LA2 with a higher arc voltage is used. However, if such an UV lamp LA2 is used together with a resistive ballast (the IR lamp LA1) only, the UV lamp LA2 will be poorly stabilized and the harmonic distortion of the lamp current ILA2 will further increase. However, if on top the resistive ballast also the HF power source OSC is implemented these drawbacks can be minimized by activating the HF power source OSC during at least the zero current gaps of the mains current IP. Now, even an arc voltage of the UV lamp LA2 is possible which is otherwise impractical. For example if the arc voltage is changed into 140 V instead of 110 V, the power ratio can be improved to 1:0.65.

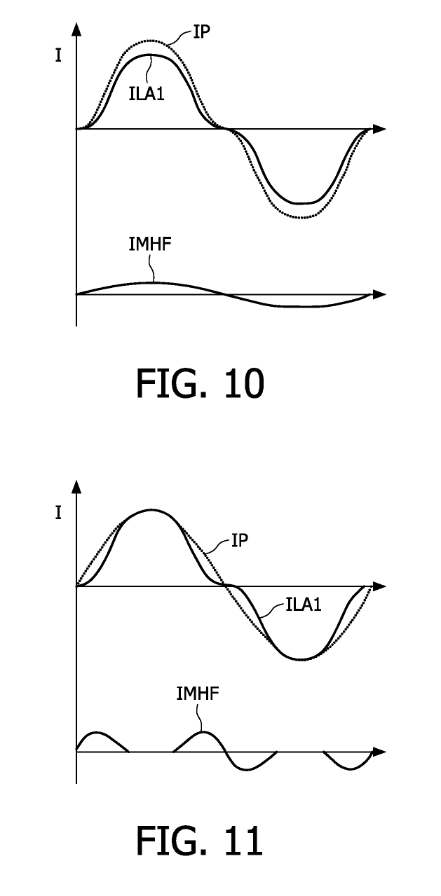

The amount of HF current supplied by the HF power source OSC during the zero current gaps may be controlled to minimize the harmonic content of the mains current IP. This will be elucidated in more detail with respect to FIGS. 10 and 11.

FIG. 6 shows schematically another embodiment of the tanning apparatus with a high frequency generator. The circuit shown in FIG. 6 only differs from the circuit in FIG. 5 that the impedance Z1 is a HF blocking inductor and in that the impedance Z2 is a LF blocking capacitor.

FIGS. 7A and 7B respectively show the current through the UV lamp without and with the high frequency generator. Both FIGS. 7A and 7B show the current ILA2 through the UV lamp LA2 along the vertical axis and the time t along the horizontal axis. FIG. 7A shows the current ILA2 through the UV lamp LA2 if the HF power source OSC is inactive. The current ILA2 through the UV lamp LA2 is now delivered by the mains PS only, and is thus identical to the mains current IP. The zero current gaps are clearly visible. FIG. 7B shows the current through the UV lamp LA2 if the HF power source OSC is active during the zero current gaps.

The intermittent operation of the HF power source OSC has two advantages. Firstly, a continuously active HF power source OSC easily excites acoustic resonances in the UV lamp LA2. These resonances are minimized or even prevented by only switching on the HF power source OSC during short periods in time. Secondly, it appeared that if a HF current IOSC is superimposed on the LF current IP outside the zero current gaps, the HF power source OSC only supplies imaginary power the UV lamp LA2.

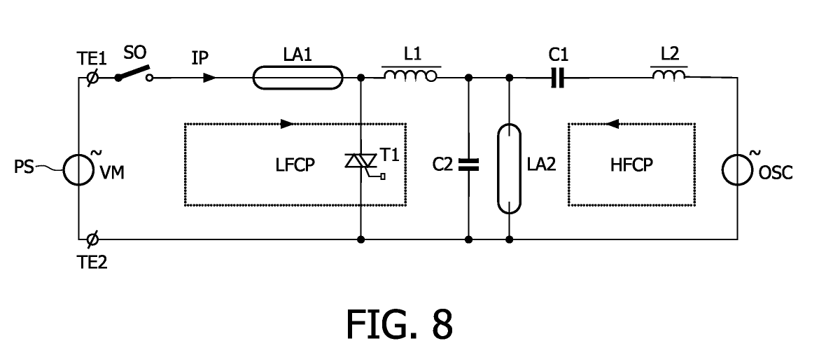

FIG. 8 shows schematically another embodiment of the tanning apparatus with a high frequency generator which has a controllable frequency. The only differences between the circuit of FIG. 8 and the circuit of FIG. 6 are that now the inductor L2 is added in series the capacitor C1, that the capacitor C2 is added in parallel with the UV lamp LA2, and that the switch T1 is shown to be a triac.

It has to be noted that the HF power source OSC has a controllable frequency, for example in the range from 100 kHz to 150 kHz. The inductor L2 is added because usually the HF power source OSC is a voltage source and the UV lamp LA2 must be current driven. The resonance frequency of the capacitor C1 and the inductor L2 is selected lower than the lowest frequency of the HF power source OSC such that the series arrangement of the capacitor C1 and the inductor L2 indeed always act as an inductance over the complete frequency range. For example, the resonance frequency of the capacitor C1 and the inductor L2 is selected to be 80 kHz.

The resonance frequency of the capacitor C2 and the inductor L2 is selected to be higher than the lowest frequency of the HF power source OSC, for example, this resonance frequency is selected to be about 130 kHz. If the HF power source OSC has this frequency, the voltage supplied by the HF power source OSC is boosted and the UV-lamp LA2 is ignited. A separate series starter is now not required. Dependent on the UV-lamp LA2 used, the required ignition voltage may be about 2.5 kV. In a practical implementation, the frequency of the HF power source OSC sweeps from a value (in this example 150 kHz) above the resonance frequency of the capacitor C2 and the inductor L2 via the resonance frequency of the capacitor C2 and the inductor L2 (in this example 130 kHz) to its lowest frequency (in this example 100 kHz). The lowest frequency is higher than the resonance frequency of the capacitor C1 and the inductor L2 (in this example is 80 kHz). This frequency sweep of the HF power source OSC ensures that the UV lamp LA2 is ignited (at about the resonance frequency of the capacitor C2 and the inductor L2) and has an inductive element in series with it when the UV lamp LA2 is in normal operation at the lowest frequency of the HF power source OSC.

Now, returning back to the limitation of the start up current drawn from the mains without requiring a NTC resistor, the operation of the circuit shown in FIG. 8 is elucidated, by way of example, for the particular implementation discussed hereinabove. In cold condition, the resistance of the IR lamp LA1 is very low (2 to 4 ohm). By controlling the conduction angle of the triac T1, the IR lamp LA1 is pre-heated. The conduction angle is gradually increased from 0° to 180° in a relatively short period in time, which is preferably shorter than 10 seconds. The resistance of the IR lamp LA1 increases and after a particular period in time the triac T1 is switched off, and the HF power source OSC is switched on, starting at a high frequency of about 150 kHz. The frequency of the HF power source OSC sweeps from 150 kHz to 100 kHz. When the frequency passes the resonance frequency of the capacitor C2 and the inductor L2 (130 kHz) the UV lamp LA2 ignites. Directly after the UV lamp LA2 has ignited, the resistance of the UV lamp LA2 is very low, but the lamp current ILA2 is limited to a desired value due to the relatively high resistance of the pre-heated IR lamp LA1. During the run-up period, the temperature in the UV lamp LA2 rises and its “resistance” increases to its nominal value of 40 Ohms. After the ignition of the UV lamp LA2, the frequency of the HF power source OSC drops to its minimal value.

If the UV lamp LA2 is ignited without first pre-heating the IR lamp LA1, very high inrush current peaks (up to 80 A per UV lamp) are drawn from the mains PS. If the pre-heat process is performed within 10 seconds, no problems arise with IEC regulations because these prescribe to measure the harmonic currents drawn from the mains 10 seconds after power on.

The position of the triac T1 as shown in FIG. 8 has the advantage that it is possible to operate the appliance in the IR mode (the relax mode) only in which the IR lamp LA1 is on but the UV lamp LA2 is off. Preferably, the switching on of the triac T1 is performed by gradually increasing its conduction angle to minimize the inrush current caused by the low resistance of the cold IR lamp LA1. A further advantage of the shown position is that if a failure occurs in the on/off switch SO, for example, a sticking of its contacts, the UV lamp LA2 can be switched off by activating the triac T1. Although now the IR lamp is continuously on, this is not in conflict with the standards.

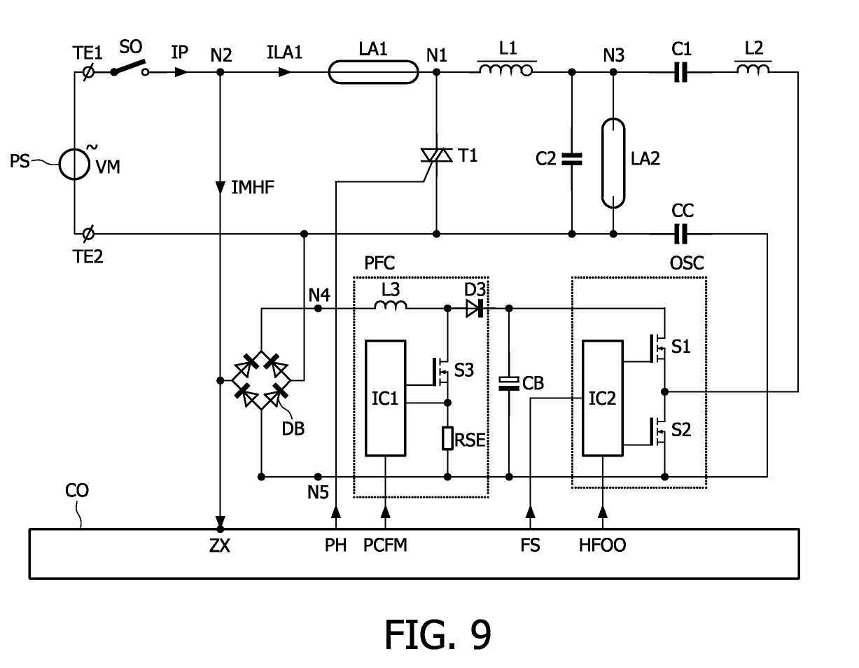

FIG. 9 shows a more detailed embodiment of the tanning apparatus. The tanning apparatus comprises the terminal TE1 and TE2 to receive power from an LF power source PS which usually is the mains and supplies a mains voltage VM. The terminal TE1 is connected to a node N2 via an on/off switch SO. The LF power source PS supplies the LF current IP. The IR lamp LA1 is arranged between the nodes N1 and N2. The current through the IR lamp LA1 is referred to as ILA1. The triac T1 is arranged between the node N1 and the terminal TE2. The blocking inductor L1 is arranged between the nodes N1 and N3. The parallel arrangement of the capacitor C2 and the UV lamp LA2 is arranged between the node N3 and the terminal TE2.

The HF power source OSC comprises a driver stage IC2 and a half bridge output stage formed by controllable switches S1 and S2. The driver stage IC2 receives an input signal FS which controls the frequency sweep of the HF power source OSC, and a switch signal HFOO which indicates when the HF power source OSC should be active and when not. The junction of the controllable switches S1 an S2, which are shown to be MOSFETs, is connected to the node N3 via the series arrangement of the capacitor C1 and the inductor L2. When the HF power source OSC is active, square pulse are generated at the junction of the controllable switches S1 an S2. A rectifier DB, which, by way of example, is shown to be a full bridge, rectifies the mains voltage present between the node N1 and the terminal TE2 if the on/of switch SO is closed. The rectified mains voltage is supplied between the nodes N4 and N5. The node N5 is connected to the terminal TE2 by the coupling capacitor CC. An optional power factor converter PFC supplies the rectified mains voltage to a buffer capacitor CB which supplies the power supply voltage of the HF power source OSC. The power factor converter PFC comprises a series arrangement of an inductor L3 and a rectifier D3 arranged between the node N4 and a terminal of the buffer capacitor CB. A series arrangement of a switch S3 and a sense resistor RSE is connected between the node N5 and on the other hand the junction of the inductor L3 and the rectifier D3. The driver IC1 controls the on and off periods of the switch S3 in response to the feedback voltage across the sense resistor RSE and a control signal PCFM generated by the controller CO. The operation of the power factor converter PFC is not further elucidated because such a power factor converter PFC is well known to the skilled person.

The controller CO has an input ZX to receive the voltage at the node N2. The controller CO detects at its input ZX whether the on/off switch SO is moved into the on-position. The controller supplies the signals PH, PCFM, FS, and HFOO. The signal PH controls the on/off state of the triac T1, and the signal PCFM controls the operation of the power factor converter PFC. The power factor converter PFC removes the high frequency power supply current drawn by the HF power source OSC from the current IMHF which is drawn from the mains via the on/off switch SO. This decreases a harmonic content of the current IMHF.

After detection of the closing of the on/off switch SO, the controller CO switches on the triac T1, preferably with an increasing conduction angle, to pre-heat the IR lamp LA1. Once the IR lamp LA1 is sufficiently pre-heated, the triac T1 is switched off. The frequency of the HF power source OSC starts decreasing from its maximum frequency and at the resonance frequency of the capacitor C2 and the inductor L2 the UV lamp LA2 is ignited. The frequency of the HF power source OSC is further lowered to stop the ignition phase and to enter the normal operation mode wherein the HF power source OSC intermittently supplies power to the UV lamp LA2 during the zero current gaps which occur if the HF power source OSC would not be present.

FIG. 10 shows several currents elucidating the effect of the high frequency generator. FIG. 10 shows at the bottom hand the input current IMHF of the diode bridge DB in front of the power factor converter PFC if the power factor converter PFC is controlled by the signal PCFM to obtain a sinusoidal input current. The upper hand part of FIG. 10 shows a full line which indicates the current ILA1 through the series arrangement which comprises the IR lamp LA1 and the UV lamp LA2. The dotted line indicates the mains current IP which is the sum of the currents ILA1 and IMHF. It has to be noted that the zero current gaps (which occur if no HF power source OSC is present) are prevented by intermittently activating the HF power source OSC. Consequently, the amount of harmonic distortion is much less than if no HF power source is used. However, the current IP drawn from the mains is still not sinusoidal.

FIG. 11 shows several currents elucidating the effect of the high frequency generator. Now the power factor converter PFC is controlled with the signal PCFM to draw a current IMHF from the mains which is shaped as shown in the bottom hand signal of FIG. 11. This shape is selected such that the total current IP which is the sum of the current ILA1 and IMHF is, or is more near to, a sinusoidal shape. This control of the power factor converter PFC further decreases the amount of harmonic distortion in the mains current IP.

It should be noted that the above-mentioned embodiments illustrate rather than limit the invention, and that those skilled in the art will be able to design many alternative embodiments without departing from the scope of the appended claims.

For example, although the embodiment described in the detailed description of the Figures are directed to a tanning apparatus, any apparatus which has to generate UV radiation suitable to radiate a person and having another effect in mind than tanning is covered by the present invention.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An apparatus for radiating an object with UV-radiation, the apparatus comprising:
a series arrangement of an incandescent lamp (LA1) and a gas discharge UV lamp (L2) generating at least UV light, wherein the series arrangement is arranged for receiving current (IP) from an AC power source (PS),
a controllable switching element (T1) being arranged for obtaining a lamp current (ILA1) through the incandescent lamp (LA1) to preheat the incandescent lamp (LA1) before igniting the gas discharge UV lamp (L2).

2. An apparatus as claimed in claim 2, further comprising an igniter (IG) for generating an ignition voltage (VIG) to ignite the gas discharge UV lamp (L2) after the incandescent lamp (LA1) has been pre-heated.

3. An apparatus as claimed in claim 1, further comprising a controller (CO) for controlling the controllable switching element (T1) to obtain the lamp current (ILA1).

4. An apparatus as claimed in claim 3, wherein the controller (CO) is constructed for controlling the switching element (T1) to obtain a lamp current (ILA1) increasing in time.

5. An apparatus as claimed in claim 1, having a first input terminal (TE1) and a second input terminal (TE2) for receiving the current (IP) from the power source (PS), the series arrangement being coupled between the first input terminal (TE1) and the second input terminal (TE2), the switching element (T1) being arranged for, when conductive, coupling the incandescent lamp (LA1) between the first input terminal (TE1) and the second input terminal (TE2), thereby forming a short circuit for a voltage (VLA2) across the gas discharge UV lamp (LA2).

6. An apparatus as claimed in claim 5, further comprising a failure detector (FD1) for detecting a failure in the apparatus, and wherein the controller (CO) is constructed to activate the switching element (T1) to obtain the lamp current (ILA1) while forming the short-circuit for the voltage (VLA2) across the gas discharge UV lamp (LA2).

7. An apparatus as claimed in claim 6, further comprising an on-off switch (SO) being arranged in series with the series arrangement, and wherein the failure detector (FD1) is arranged for detecting a sticking of contacts of the on-off switch (SO).

8. An apparatus as claimed in claim 5, further comprising a failure detector (FD2) for detecting whether the controller (CO) is correctly operating, and a relay (RE) for disconnecting the apparatus from the AC power source (PS) if the failure detector (FD2) detects an incorrectly operating controller (CO).

9. An apparatus as claimed in claim 8, wherein the controller comprises an output (RD) for supplying an pulse (RP), and wherein the failure detector (FD2) is constructed for controlling the relay (RE) to disconnect the apparatus if the pulse (RP) deviates from predefined characteristics.

10. An apparatus as claimed in claim 1, further comprising a generator (OSC) for generating a generator current (IOSC) through the gas discharge UV lamp (LA2), at least when an AC-voltage (VM) generated by the AC power source (PS) is lower than an ignition voltage of the gas discharge UV lamp (LA2), to keep the gas discharge UV lamp (LA2) ionized.

11. An apparatus as claimed in claim 10, wherein the generator (OSC) is constructed for generating the generator current (IOSC) having a repetition frequency higher than a frequency of the AC power source current (IP).

12. An apparatus as claimed in claim 11, wherein the repetition frequency of the generator current (IOSC) is within the range 50 kHz to 150 kHz, and wherein the AC power source (PS) is the mains.

13. An apparatus as claimed in claim 11, further comprising a first impedance (Z1) arranged between the AC power source (PS) and the incandescent lamp (LA1) for attenuating an amount of the generator current (IOSC) flowing through the incandescent lamp (LA1) to the AC power source (PS), and a second impedance (Z2) arranged between the generator (OSC) and gas discharge UV lamp (LA2) for attenuating an amount of the AC power source current (IP) flowing through the generator (OSC).

14. An apparatus as claimed in claim 13, wherein the first impedance (Z1) is a first inductor (L1) and the second impedance (Z2) is a first capacitor (C1).

15. An apparatus as claimed in claim 14, further comprising
a second capacitor (C2) being arranged in parallel with the gas discharge UV lamp (LA2) and a second inductor (L2) being arranged in series with the first capacitor (C1), and wherein a first resonance frequency of the first capacitor (C1) and the second inductor (L2) is lower than a minimal value of the repetition frequency of the generator current (IOSC), and wherein a second resonance frequency of the second capacitor (C2) and the second inductor (L2) is higher than the first resonance frequency, and wherein the controller (CO) is constructed for controlling the generator (OSC) to vary the repetition frequency starting from a value higher than the second resonance frequency to the minimal value.

16. An apparatus as claimed in claim 1, wherein the controllable switching element (T1) comprises a triac.

17. An apparatus as claimed in claim 1, wherein the incandescent lamp (LA1) comprises an IR lamp for emitting at least infrared light.

18. A tanning apparatus comprising the apparatus as claimed in claim 1.
